(19) United States
(12) Patent Application Publication
(10) Pub. No.: US 2026/0080581 A1
(43) Pub. Date: Mar. 19, 2026

(54) GENERATION OF SYNTHETIC IMAGES FOR TRAINING OF DEFECT DETECTION MODELS

(71) Applicant: Intel Corporation, Santa Clara, CA (US)

(72) Inventors: Jiaxiang Jiang, Santa Clara, CA (US); Mahesh Subedar, Folsom, CA (US); Jennifer Marie Williams, Hillsboro, OR (US); Amrutha Machireddy, Bengaluru (IN)

(73) Assignee: Intel Corporation, Santa Clara, CA (US)

(21) Appl. No.: 19/399,089

(22) Filed: Nov. 24, 2025

(51) Int. Cl. G06T 11/00; G06N 20/00

(52) U.S. Cl. CPC G06T 11/00; G06N 20/00

(57) ABSTRACT

Systems, apparatus, articles of manufacture, and methods to generate synthetic images for training of defect detection models are disclosed. An example system disclosed herein produces synthetic images of pallet defects to train object detection models. In some examples, a small set of real images containing defects, associated masks and textual descriptions is used to fine tune a latent diffusion model. The fine-tuned model accepts a masked input image, a mask that defines the region to be altered, and a defect description, and generates a synthetic image with the defect inpainted into the masked region. In some examples, generated synthetic images are filtered to remove outliers that do not match the real defect distribution. The filtered synthetic dataset, together with a limited set of real images, is then used to train a downstream object detection model capable of identifying pallet damage in captured images.

### BACKGROUND

Automatic defect detection has many practical applications in a wide variety of industries, such as manufacturing, automotive, shipping, etc. One such practical application of automatic defect detection is in the global pallet inspection industry.

### BRIEF DESCRIPTION OF THE DRAWINGS

FIG. 1 is a block diagram of an example defect detection system to detect defects in an example warehouse environment.

FIG. 2 is a block diagram of an example implementation of an artificial intelligence (AI) model provisioning system included in the defect detection system of FIG. 1.

FIG. 3 is a block diagram of example implementation of a diffusion model finetuning circuitry included in the defect detection circuitry of FIG. 2.

FIG. 4 is a block diagram of example implementation of a synthetic image generation circuitry included in the defect detection circuitry of FIG. 2.

FIG. 5 is a flowchart representative of example machine-readable instructions and/or example operations that may be executed, instantiated, and/or performed by example programmable circuitry to implement the defect detection circuitry of FIGS. 2-4.

FIG. 6 is a flowchart representative of example machine-readable instructions and/or example operations that may be executed, instantiated, and/or performed by example programmable circuitry to implement synthetic image generation in the defect detection circuitry of FIGS. 2-4.

FIG. 7 is a flowchart representative of example machine-readable instructions and/or example operations that may be executed, instantiated, and/or performed by example programmable circuitry to implement input data generation in the defect detection circuitry of FIGS. 2-4.

FIG. 8 is a flowchart representative of example machine-readable instructions and/or example operations that may be executed, instantiated, and/or performed by example programmable circuitry to implement diffusion model tuning in the defect detection circuitry of FIGS. 2-4.

FIG. 9 is a flowchart representative of example machine-readable instructions and/or example operations that may be executed, instantiated, and/or performed by example programmable circuitry to implement tuning data generation in the defect detection circuitry of FIGS. 2-4.

FIG. 10 is a block diagram of an example processing platform including programmable circuitry structured to execute, instantiate, and/or perform the example machine-readable instructions and/or perform the example operations of FIGS. 5-9 to implement the AI model provisioning system of FIGS. 2-4.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine-readable instructions of FIGS. 5-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Automated pallet defect detection can play an important role in many industries, such as in the global pallet inspection industry, by reducing human inspection error while enhancing efficiency and reporting rate for liability claims. Some technologies for automated pallet defect detection adapt object detection models in computer vision to detect defects or damage regions in images of pallets However, training such object detection models may require a large number of training pallet images containing defects. However, obtaining a sufficient amount of training data is challenging due to the unbalanced nature of the dataset as there are typically many more instances of undamaged or otherwise good pallets than damaged or otherwise bad pallets. Gathering a sufficient number of training images depicting damaged pallets for model training can take an unacceptable amount of time to occur in situ and may be costly to annotate by a subject matter expert. The foregoing is also true for many other practical applications of defect detection in other industries in which defects are an issue, such as manufacturing, shipping, logistics, etc. Some existing data augmentation techniques for training object detection models utilize conventional image processing techniques to augment training datasets with additional training images having varying image brightness, contrast, aspect ratio etc. However, such conventional techniques provide limited performance improvement because they do not model actual object defects in the training images.

Example systems, apparatus, articles of manufacture, methods, etc., disclosed herein generate synthetic images for training of defect detection models. As such, examples disclosed herein can provide technical solutions to the foregoing technical problems of obtaining sufficient training data to meet target/desired defect detection accuracy.

Example synthetic image generation techniques disclosed utilize a diffusion model to learn the distribution of defects of interest and then generate synthetic images with appropriate defect regions that can be used to train an object detection model. In some such examples disclosed, generative artificial intelligence (AI) in the form of a diffusion model is employed to generate synthetic pallet defect images to enable training of a downstream object detection model with a sufficient amount of training data to meet a target/desired accuracy. Some examples disclosed herein learn the data distribution of pallet defect regions and then inpaint existing images with the learned defect knowledge. For example, the generative model of some example synthetic image generation techniques disclosed can be used to simulate new defects on undamaged (non-defective) regions of a pallet depicted in an image, or modify existing defect regions to create additional images with different defects styles.

As described in further detail below, some example synthetic image generation techniques disclosed herein finetune a trained latent diffusion model based training images containing defects, masks to mask the defect areas, masked training images in which the defect areas are masked, and defect descriptions. In some examples, such finetuning can yield a tuned latent diffusion model for synthetic image generation which has been refined based on tens of training images with defects rather than the thousands of images typically employed for model training. Some example synthetic image generation techniques disclosed herein then use (e.g., sample) the tuned latent diffusion model to inpaint existing images with synthetic pallet defects to yield an initial set of synthetic images. Some examples disclosed herein further filter the initial set of synthetic images to remove outlier images and keep in-distribution samples. Some examples disclosed herein then train an object detection model with a training dataset including a combination of the filtered synthetic dataset and a real data set including real images of object defects (e.g., pallets with defects).

Examples disclosed herein can provide several advantages. For example, synthetic image generation implemented as disclosed herein can provide rapid generation of training data depicting simulated defects in a time frame much shorter than waiting for actual defects to occur in situ. Also, examples implemented as disclosed herein can improve detection accuracy, reduce manual effort, and/or improve efficiency in defect detection applications because only tens of annotated images are needed to finetune the generative model used to generate the synthetic images for training the object detection model. Furthermore, examples implemented as disclosed herein can output synthetic images with targeted defect injection (inpainting) in realistic locations on pallets based on observed defect distributions.

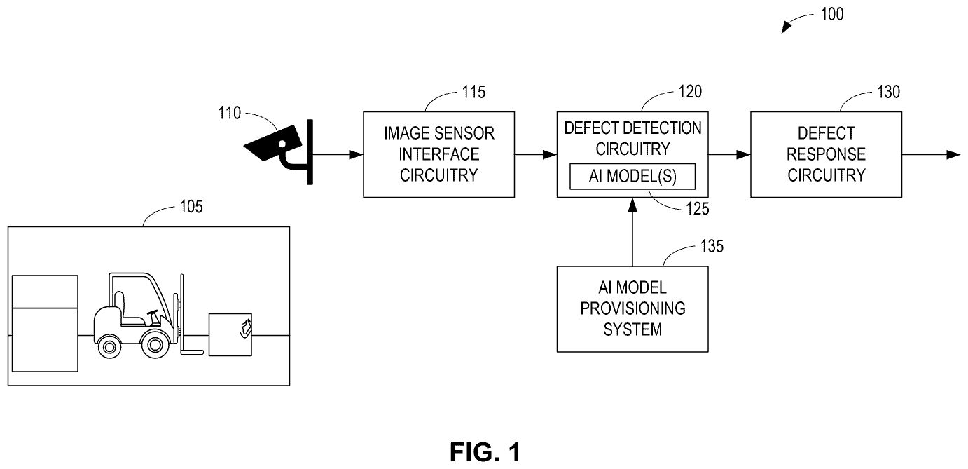

Turning to the figures, FIG. 1 is a block diagram of an example defect detection system 100 to detect defects in an example environment 105. The defect detection system 100 of FIG. 1 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the defect detection system 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example environment 105 of FIG. 1 corresponds to a warehouse, a commercial building (e.g., a retail stores, a shipping facility, etc.) or any other setting in which one or more example camera sensors 110 are deployed to detect defects associated objects in the environment. For example, the camera sensor(s) 110 may be deployed to detect defects on pallets being received, moved and/or stored in a warehouse or other facility. The camera sensor(s) 110 may be implemented by one or more visible light cameras, infrared cameras, image sensors, etc., capable of capturing images and/or video of objects in an environment such as the environment 105.

The example defect detection system 100 of FIG. 1 includes the camera sensor(s) 110, example image sensor interface circuitry 115, example defect detection circuitry 120 that executes, implements or otherwise includes one or more example artificial intelligence (AI) models 125, example defect response circuitry 130 and an example AI model provisioning system 135. The image sensor interface circuitry 115 of the illustrated example receives, obtains or otherwise accesses camera sensor data from the camera sensor(s) 110. For example, the camera sensor data from a given camera sensor 110 can include image data (e.g., such as one or more still images) and/or video data (e.g., such as one or more video clips, continuous video, etc.).

The defect detection circuitry 120 of the illustrated includes the AI model(s) 125, such as one or more machine learning (ML) models, which are trained to detect defects associated with objects depicted in the camera sensor data from the camera sensor(s) 110. For example, the ML model(s) 125 may be trained to detect defects associated with pallets in the warehouse environment 105, as illustrated in the example of FIG. 1. The AI model(s) may include any number and/or types of ML model(s), neural network(s), etc., and/or any other AI model. In the illustrated example of FIG. 1, the AI model(s) 125 included an object detection model that is trained to detect one or more particular classes of defects (e.g., such as crush damage, slice damage, water damage, etc.) on one or more particular classes of objects (e.g., such as pallets) depicted in images obtained from the camera sensor(s) 110.

The defect response circuitry 130 of the illustrated example generates one or more responses that are triggered by detection of a defect by the defect detection circuitry 120. For example, the defect response circuitry 130 can output an image depicting the object having the detected defect, along with a bounding box, annotation, etc., identifying a location of the defect in the image, identifying a class/type of the defect, etc. Additionally or alternatively, the defect response circuitry 130 can generate an alert, such as a message containing the output image, and communicate the alert to one or more specified recipients. Additionally or alternatively, the defect response circuitry 130 can issue one or more commands, instructions, etc., to one or more actuators, systems, circuits, etc., to initiate one or more actions responsive to detection of the defect. For example, the defect response circuitry 130 can issue one or more commands, instructions, etc., to instruct one or more robots, conveyor belts, vehicles, etc., to move the defective object (e.g., defective pallet) to a particular location for further analysis.

The AI model provisioning system 135 of the illustrated example provides the trained AI model(s) 125 to the defect detection circuitry 120. For example, the AI model provisioning system 135 trains a given AI model 125 to detect one or more particular classes of defects (e.g., such as crush damage, slice damage, water damage, etc.) on one or more particular classes of objects (e.g., such as pallets), as described above. The AI model provisioning system 135 may then provision the trained AI model 125 to the defect detection circuitry 120. For example, the AI model provisioning system 135 may communicate (e.g., transmit, download, etc.) the weights, hyperparameters, structure, etc., of the trained AI model 125 to the defect detection circuitry 120. In the illustrated example of FIG. 1, the AI model provisioning system 135 implements synthetic image generation in accordance with teachings of this disclosure to develop a training dataset to train the AI model 125 to perform defect detection model.

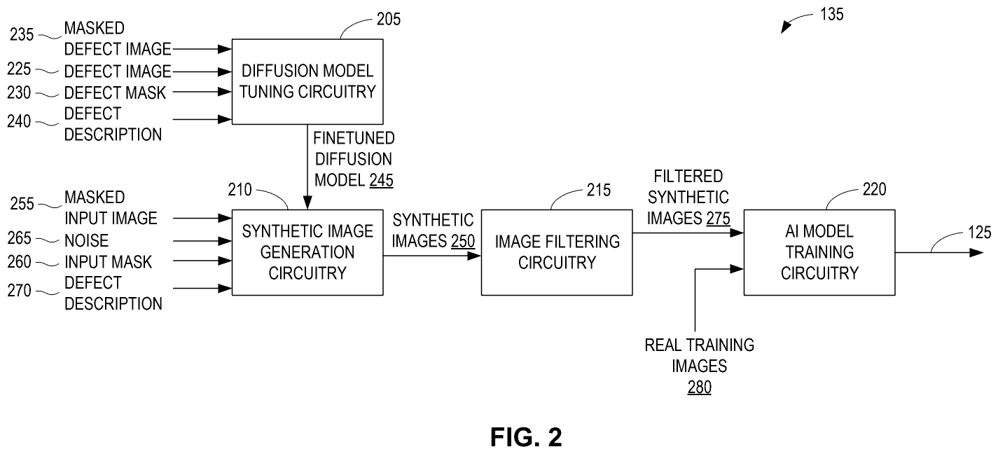

FIG. 2 is a block diagram of an example implementation of the AI model provisioning system 135 of FIG. 1. The AI model provisioning system 135 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the AI model provisioning system 135 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example AI model provisioning system 135 of FIG. 2 includes example diffusion model tuning circuitry 205, example synthetic image generation circuitry 210, example image filtering circuitry 215 and example AI model training circuitry 220. The diffusion model tuning circuitry 205 of the illustrated example operates to tune (also referred herein as finetuning) a diffusion model to inpaint defects in regions of input images to generate synthetic images depicting objects with defects. A diffusion model is a type of generative AI model trained to synthesize images or portions of images from noise (e.g., noise data) input to the diffusion model by learning to reverse an iterative noise addition process. Some diffusion models operate in pixel space and work on data having the dimensions of the output image. However, some diffusion models, referred to as latent diffusion models, operate in latent space and, thus, work on data having a reduced dimensionality relative to the final output image. Latent diffusion models can be preferable over standard diffusion models as they may utilize less memory resources, less computation resources, etc.

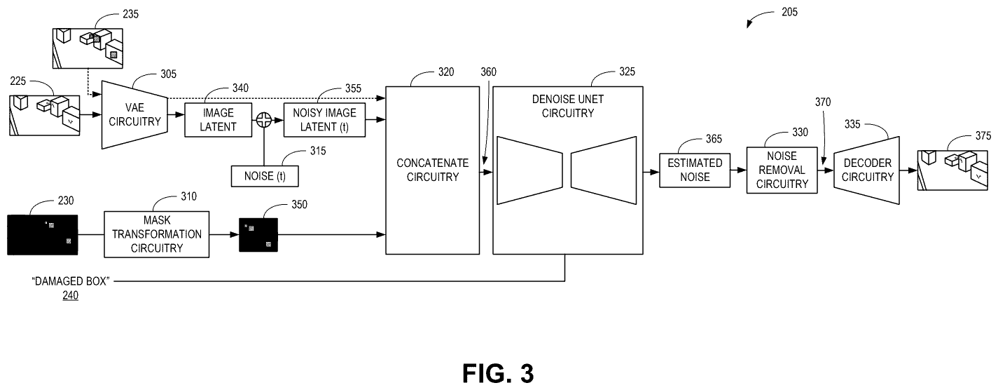

As disclosed in further detail, the diffusion model tuning circuitry 205 of the illustrated example operates to finetune a latent diffusion model to inpaint defects in regions of input images to generate synthetic images depicting objects with defects. As further disclosed below, the diffusion model tuning circuitry 205 tunes the latent diffusion model based on a combination of (i) example training defect images 225 that depict defects of interest in objects of interest, (ii) example defect masks 230 that identify the respective defect regions in the corresponding training defect images 225, (iii) example masked defect images 235 generated by applying the respective masks to the corresponding training defect images, and (iv) example defect description data 240 that describes the respective defects depicted in the corresponding training defect images 225. The diffusion model tuning circuitry 205 outputs the result of the tuning as an example tuned diffusion model 245, which is an example tuned latent diffusion model 245 in the illustrated example. An example implementation of the diffusion model tuning circuitry 205 is illustrated in FIG. 3, which is described in further detail below.

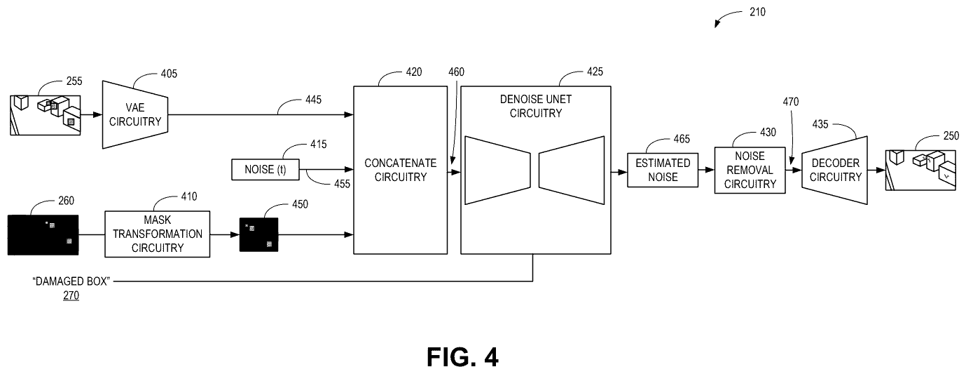

The synthetic image generation circuitry 210 of the illustrated example operates to generate synthetic images based on the tuned diffusion model 245 (e.g., the tuned latent diffusion model 245) provided by the diffusion model tuning circuitry 205. For example, the synthetic image generation circuitry 210 uses the tuned diffusion model 245 to inpaint a synthetic defect into a masked region of an input image to generate a synthetic image in which an object depicted in the input image exhibits the synthetic defect. In the illustrated example, the tuned diffusion model 245 generates the synthetic defect based on input noise (e.g., noise data). As such, the synthetic image generation circuitry 210 of the illustrated example generates example synthetic images 250 based on a combination of (i) example masked input images 255 generated by applying the respective example masks 260 to corresponding input images into which defects are to be inpainted, (ii) the example input masks 260 that identify the respective masked defect regions in the corresponding masked input images 255, (iii) example noise 265 used by the tuned diffusion model 245 (e.g., the tuned latent diffusion model 245) to inpaint the synthetic defects in the masked defect regions in the corresponding masked input images 255, and (iv) example defect description data 270 that describes the respective defects to be inpainted in the corresponding masked input images 255. An example implementation of the synthetic image generation circuitry 210 is illustrated in FIG. 4, which is described in further detail below.

The image filtering circuitry 215 of the illustrated example filters outlier image(s) from the initial set synthetic images 250 generated by the synthetic image generation circuitry 210 to produce an example set of filtered synthetic images 275 that excludes the outlier image(s). Examples of outlier images include, but are not limited to, synthetic images having inpainted synthetic defects that (i) do not correspond to the class/type of defect specified by the defect description data 270, (ii) are not properly sized, shaped, etc., to fit their respective masked defect regions, (iii) are not properly blended or otherwise matched with the rest of the surrounding synthetic image, etc., or any combination thereof. The image filtering circuitry 215 can implement any appropriate filtering technique or combination of techniques to filter the outlier image(s) from the synthetic images 250 to produce the filtered synthetic images 275. Examples of such filtering techniques include out-of-distribution techniques, autoencoder techniques, etc.

In some examples, the image filtering circuitry 215 implements an out-of-distribution technique to filter, from the synthetic images 250, outlier image(s) that have inpainted synthetic defects with features that deviate by at least a threshold amount (e.g., a threshold distance) from a distribution of real defects depicted in a set of real defect images, such as the training defect images 225 and/or another set of real defect images. The real defects depicted in a set of real defect images correspond to the class(es) of defects to be synthesized by the synthetic image generation circuitry 210. In some such examples, the image filtering circuitry 215 inputs the real defect images to any AI model trained to operate on images and extracts features (or embeddings) from one or more layers of the AI model. The image filtering circuitry 215 generates a distribution, such as a Gaussian distribution, based on the extracted features (or embeddings). The image filtering circuitry 215 then uses the generated distribution to determine whether a given synthetic image 250 has features that are consistent with the distribution or deviate from the distribution (e.g., are out-of-distribution). For example, the image filtering circuitry 215 inputs a given synthetic image 250 into the same AI model used to generate the distribution and extracts features (or embeddings) associated with the given synthetic image 250 from the one or more layers of the AI model. In some such examples, the image filtering circuitry 215 then computes a distance or other metric based on the extracted features (or embeddings) associated with the given synthetic image 250 to determine whether the given synthetic image 250 belongs to the distribution of defect images. For example, if the distance or other metric do not satisfy (e.g., exceeds) a distance threshold, the image filtering circuitry 215 determines the given synthetic image 250 is an outlier image and excludes that image from the filtered synthetic images 275. However, if the distance or other metric satisfies (e.g., is less than or equal to) the distance threshold, the image filtering circuitry 215 includes the given synthetic image 250 in the filtered synthetic images 275.

In some examples, the image filtering circuitry 215 additionally or alternatively implements an autoencoder technique to filter the outlier image(s) from the synthetic images 250. In some such examples, the image filtering circuitry 215 trains an autoencoder based on a set of real defect images, such as the training defect images 225 and/or another set of real defect images, that include real defects corresponding to the class(es) of defects to be synthesized by the synthetic image generation circuitry 210. Once trained, the autoencoder can encode images depicting the class(es) of defects into a smaller (e.g., compressed) coding space. The encoded images can then be decoded by a corresponding decoder into decoded image that will substantially match the original images. However, if the trained autoencoder is used to encode an image that differs from the types of images used for training, the process of encoding the image and decoding an image will yield a decoded image that differs from the original image. Thus, in some examples, the image filtering circuitry 215 uses the trained autoencoder to encode a given synthetic image 250 and then decodes the encoded image to generate a decoded image. The image filtering circuitry 215 then computes a difference between the given synthetic image 250 and the decoded image. If the difference does not satisfy (e.g., exceeds) a difference threshold, the image filtering circuitry 215 determines the given synthetic image 250 is an outlier image and excludes that image from the filtered synthetic images 275. However, if the difference satisfies (e.g., is less than or equal to) the difference threshold, the image filtering circuitry 215 includes the given synthetic image 250 in the filtered synthetic images 275.

The AI model training circuitry 220 of the illustrated example trains one or more AI models based on the filtered synthetic images 275 to detect defects depicted in images/video captured by the camera sensors 110. The AI model(s) trained by the AI model training circuitry 220 can be any type(s) of AI model(s) capable of detect defects associated with objects (e.g., pallets) depicted in an image. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a diffusion model is used to generate synthetic images capable of training any type of AI model. Using a diffusion model enables AI model provisioning system 135 to generate the synthetic images efficiently based on tuning employing a relatively small set of real images depicting defects of interest. However, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models 125 are trained by the AI model training circuitry 220 using the filtered synthetic images 275. In some examples, the AI model training circuitry 220 trains the ML/AI models 125 based on the set of filtered synthetic images 275 and an example set of real training images 280 depicting real defects associated with real objects (e.g., pallets). However, any other training algorithm may additionally or alternatively be used. In examples disclosed herein, training is performed until one or more convergence criteria are met. Training is performed using hyperparameters that control how the learning is performed (e.g., a learning rate, a number of layers to be used in the machine learning model, etc.). In examples disclosed herein, such hyperparameters are selected in any appropriate manner.

As described above, the AI model training circuitry 220 performs training the filtered synthetic images 275 as training data. In examples disclosed herein, the training data originates from the synthetic image generation circuitry 210. In some examples, the AI model training circuitry 220 employs supervised training and, thus, the training data is labeled. In some such examples, labeling is applied to the synthetic images 250 by the synthetic image generation circuitry 210 (e.g., based on the defect descriptions 270).

Once training is complete, the AI model training circuitry 220 deploys or otherwise provisions the trained AI/ML model 125 to the defect detection circuitry 120 for use as an executable construct that processes an input image data from the image sensor interface circuitry 115 and provides a defect detection output based on the network of nodes and connections defined in the model.

Once trained, the deployed AI/ML model 125 may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI/ML model 125 to transform the output into a useful result (e.g., a display of data, an instruction to be executed by a machine, etc.).

In some examples, output of the deployed AI/ML model 125 may be captured and provided as feedback. By analyzing the feedback, an accuracy of the deployed model can be determined. If the feedback indicates that the accuracy of the deployed AI/ML model 125 is less than a threshold or other criterion, training of an updated AI/ML model 125 can be triggered using the feedback and an updated training data set, hyperparameters, etc., to generate an updated, deployed model.

In some examples, tuning, or fine-tuning, an AI model, such as the diffusion models disclosed herein, involves re-fining parameters of an already trained AI model, such as an already trained diffusion model, based on a relatively small set of tuning images targeted to have particular characteristics. In some such examples, a goal of such tuning is to update the parameters of the AI model, such as the diffusion model, to improve model operation (e.g., model inference) associated with input images having similar characteristics as the tuning images. In some examples, the tuning can employ the same or different training algorithms, loss functions, etc., relative to those used to initial train the model.

In the illustrated example AI model provisioning system 135 of FIG. 2, the diffusion model tuning circuitry 205, the synthetic image generation circuitry 210, the image filtering circuitry 215 and/or the AI model training circuitry 220 may be implemented at the same location or two or more different locations. For example, the diffusion model tuning circuitry 205, the synthetic image generation circuitry 210, the image filtering circuitry 215 and/or the AI model training circuitry 220 can be implemented by one or more compute devices located at the example environment 105. In some examples, the diffusion model tuning circuitry 205, the synthetic image generation circuitry 210, the image filtering circuitry 215 and/or the AI model training circuitry 220 can be implemented by one or more compute device, one or more cloud computing platforms, etc., at one or more locations different from the example environment 105. In some examples, one or more of the diffusion model tuning circuitry 205, the synthetic image generation circuitry 210, the image filtering circuitry 215 and/or the AI model training circuitry 220 are implemented by compute device(s) located at the example environment 105, and the other one or more of the diffusion model tuning circuitry 205, the synthetic image generation circuitry 210, the image filtering circuitry 215 and/or the AI model training circuitry 220 are implemented by compute device(s), cloud platform(s), etc., at location(s) different from the example environment 105.

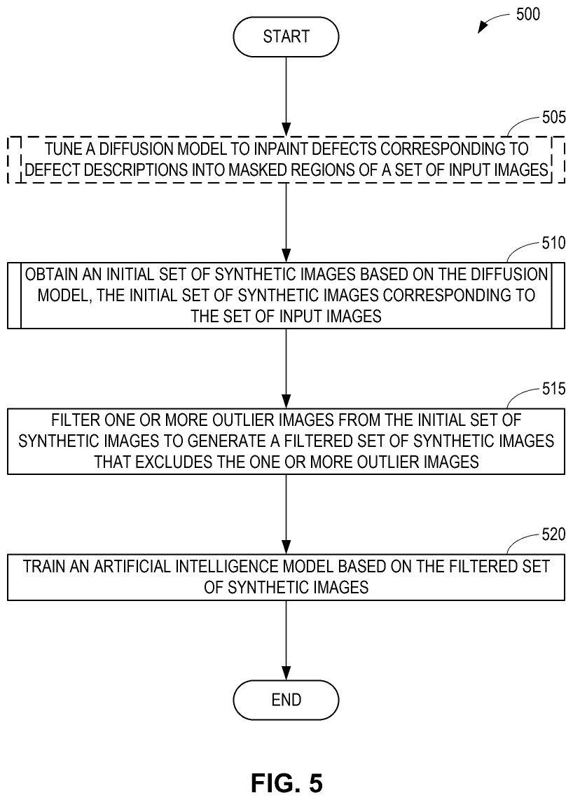

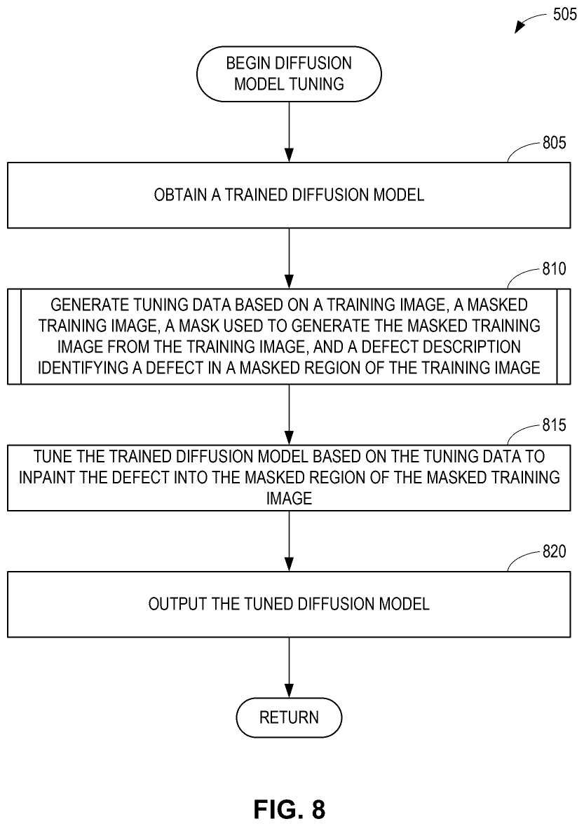

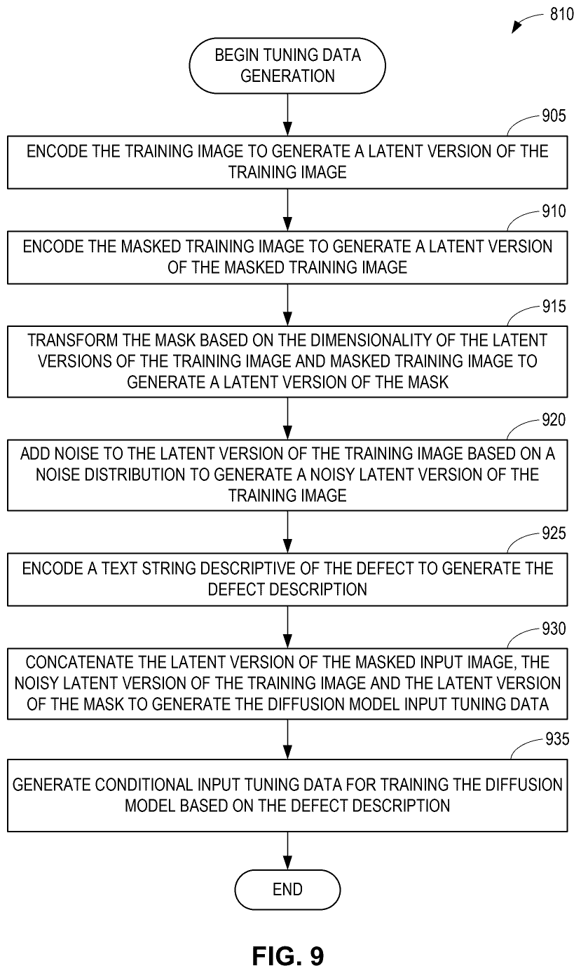

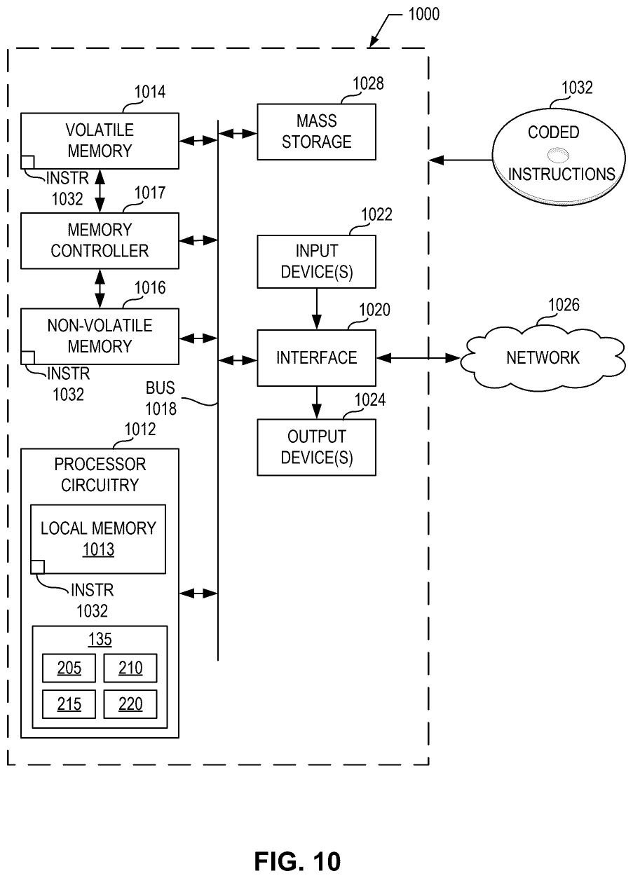

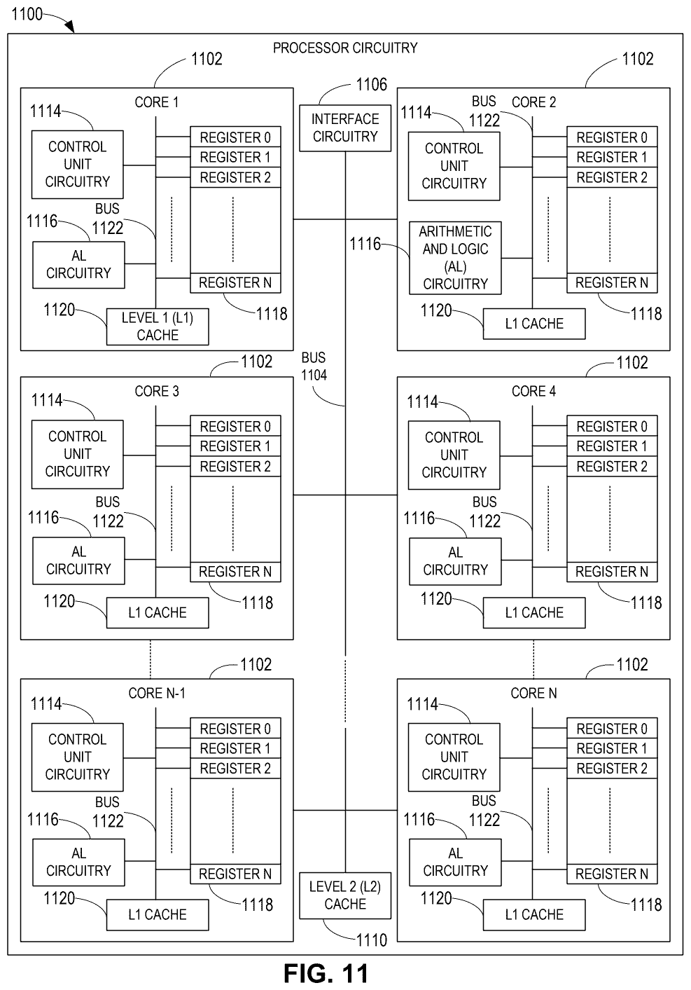

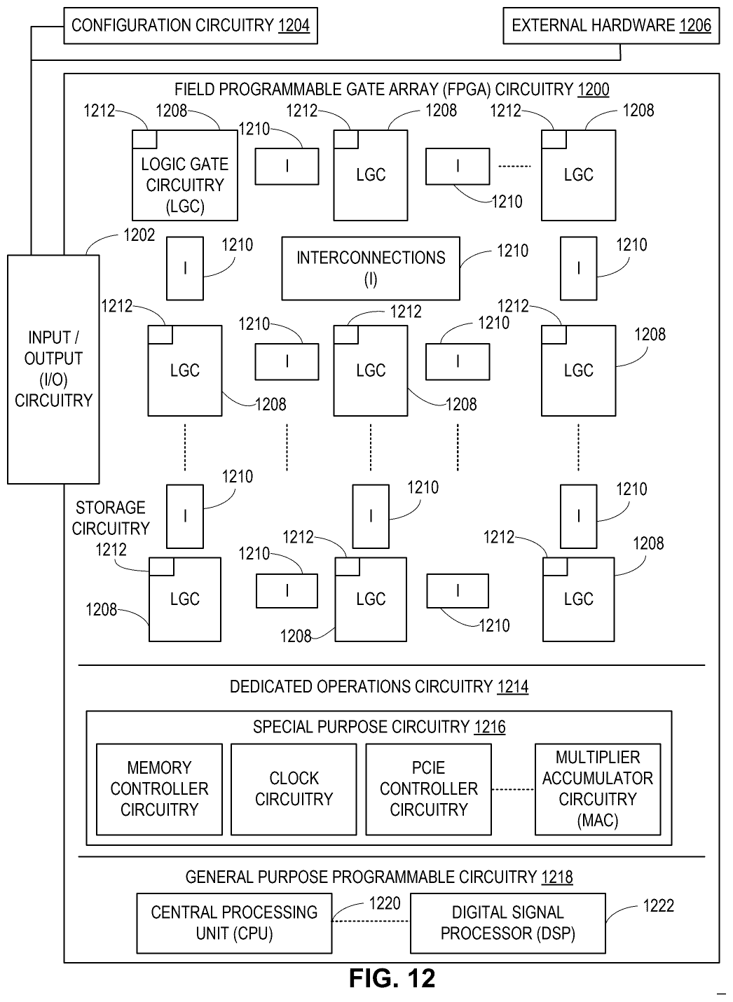

In some examples, the AI model provisioning system 135 includes means for tuning a diffusion model. For example, the means for tuning a diffusion model may be implemented by the diffusion model tuning circuitry 205. In some examples, the diffusion model tuning circuitry 205 may be instantiated by programmable circuitry such as the example programmable circuitry 1012 of FIG. 10. For instance, the diffusion model tuning circuitry 205 may be instantiated by the example microprocessor 1100 of FIG. 11 executing machine executable instructions such as those implemented by at least block 505 of FIG. 5, blocks 805-820 of FIG. 8 and/or blocks 905-930 of FIG. 9. In some examples, the diffusion model tuning circuitry 205 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the diffusion model tuning circuitry 205 may be instantiated by any other combination of hardware, software, and/or firmware. For example, the diffusion model tuning circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

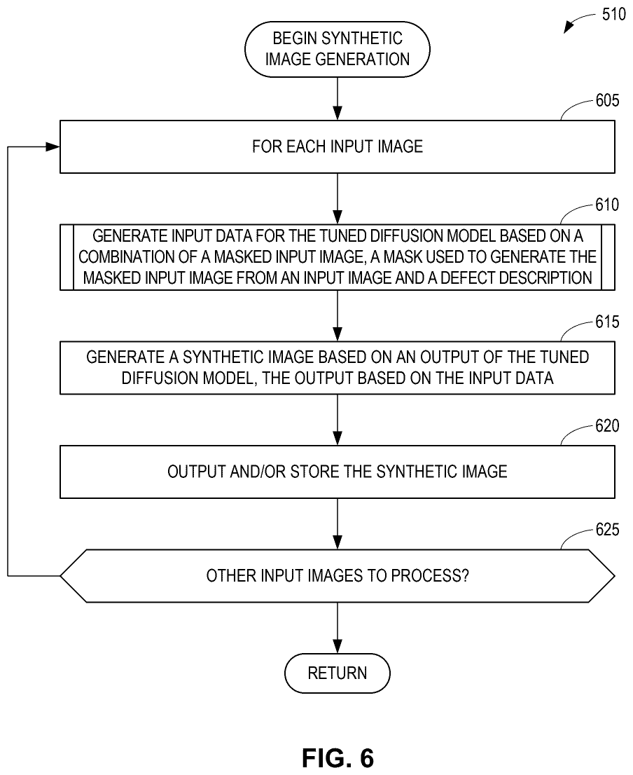

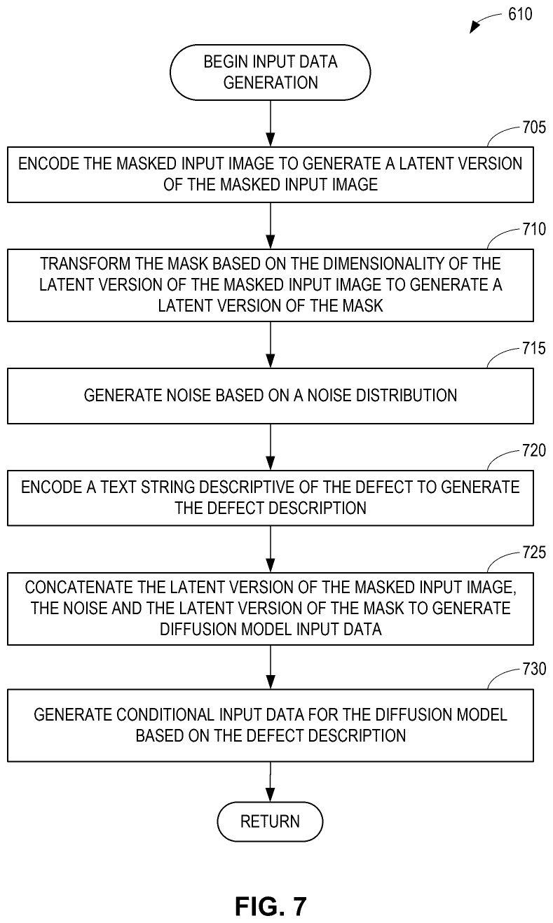

In some examples, the AI model provisioning system 135 includes means for generating synthetic images. For example, the means for generating synthetic images may be implemented by the synthetic image generation circuitry 210. In some examples, the synthetic image generation circuitry 210 may be instantiated by programmable circuitry such as the example programmable circuitry 1012 of FIG. 10. For instance, the synthetic image generation circuitry 210 may be instantiated by the example microprocessor 1100 of FIG. 11 executing machine executable instructions such as those implemented by at least block 510 of FIG. 5, blocks 605-625 of FIG. 6 and/or blocks 705-725 of FIG. 7. In some examples, the synthetic image generation circuitry 210 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the synthetic image generation circuitry 210 may be instantiated by any other combination of hardware, software, and/or firmware. For example, the synthetic image generation circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the AI model provisioning system 135 includes means for filtering synthetic images. For example, the means for filtering synthetic images may be implemented by the image filtering circuitry 215. In some examples, the image filtering circuitry 215 may be instantiated by programmable circuitry such as the example programmable circuitry 1012 of FIG. 10. For instance, the image filtering circuitry 215 may be instantiated by the example microprocessor 1100 of FIG. 11 executing machine executable instructions such as those implemented by at least block 515 of FIG. 5. In some examples, the image filtering circuitry 215 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the image filtering circuitry 215 may be instantiated by any other combination of hardware, software, and/or firmware. For example, the image filtering circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the AI model provisioning system 135 includes means for training AI models. For example, the means for training AI models may be implemented by the AI model training circuitry 220. In some examples, the AI model training circuitry 220 may be instantiated by programmable circuitry such as the example programmable circuitry 1012 of FIG. 10. For instance, the AI model training circuitry 220 may be instantiated by the example microprocessor 1100 of FIG. 11 executing machine executable instructions such as those implemented by at least block 520 of FIG. 5. In some examples, the AI model training circuitry 220 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the AI model training circuitry 220 may be instantiated by any other combination of hardware, software, and/or firmware. For example, the AI model training circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 3 is a block diagram of an example implementation of the diffusion model tuning circuitry 205 of FIG. 2. The diffusion model tuning circuitry 205 of FIG. 3 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the diffusion model tuning circuitry 205 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example diffusion model tuning circuitry 205 of FIG. 3 includes example encoder circuitry 305, example mask transformation circuitry 310, example noise generation circuitry 315, example concatenation circuitry 320, example denoise circuitry 325, example noise removal circuitry 330 and example decoder circuitry 335 to implement and train the diffusion model 245 to generate the synthetic images 250, as described above. The encoder circuitry 305 of the illustrated example accepts as input an example training defect image 225 and an example masked defect image 235. As described above, the training defect image 225 depicts one or more defects of interest in one or more objects of interest. For example, the object(s) of interest depicted in the training defect image 225 may include one or more pallets, and the defect(s) of interest depicted in the training defect image 225 may include one or more types of defects exhibited on the pallets, such as regions of crush damage, slice damage, water damage, etc.

The masked training defect image 235 is a masked version of the training defect image 225 in which defect region(s) of the training defect image 225 that include the depicted defect(s) have been masked (e.g., removed) by an example defect mask 230. For example, the masked training defect image 235 may replace the original pixels in the masked defect region(s) specified by the defect mask 230 with black pixels, white pixels, etc., and/or any other pixel type used to identify masked region(s). In some examples, the defect mask 230 is a binary mask with a first value (e.g., 0) used to represent masked region(s) of the training defect image 225 and a second value (e.g., 1) used to represent unmasked region(s) of the training defect image 225. In some such examples, the encoder circuitry 305 and/or other circuitry of the diffusion model tuning circuitry 205 multiplies the training defect image 225 by the defect mask 230 to determine the masked training defect image 235. In some examples, the defect mask 230 is provided as input to the diffusion model tuning circuitry 205 and/or generated by the diffusion model tuning circuitry 205 based on user input area specifying bounding box(es) that define the locations and/or dimensions of the defect region(s) in the training defect image 225.

The encoder circuitry 305 of the illustrated example encodes the training defect image 225 from an original pixel space into a reduced dimensionality latent space to generate and output an example latent version of the training defect image 225, also referred to as an example training defect image latent 340. For example, if the training defect image 225 has a pixel space dimensionality of H×W×3, where H represents the height of the image in pixels, W represents the width of the image in pixels, and 3 corresponds to the number of color channels (e.g., red, green, and blue in RGB format, or luminance (Y) and chrominance (U,V) in YUV format), the training defect image latent 340 may have a dimensionality of H/D×W/D×C, where D represents a dimensionality reduction factor, and C represents the number of output channels of the training defect image latent 340. Likewise, the encoder circuitry 305 of the illustrated example encodes the masked training defect image 235 into the reduced dimensionality latent space to generate and output an example latent version of the masked training defect image 235, also referred to as an example masked training defect image latent 345. The masked training defect image latent 345 has the same reduced dimensionality as the training defect image latent 340. In some examples, the encoder circuitry 305 implements an example variational autoencoder (VAE) trained to encode the training defect image 225 into the training defect image latent 340, and to encode the masked training defect image 235 into the masked training defect image latent 345.

The mask transformation circuitry 310 of the illustrated example transforms the defect mask 230 into an example latent version of the defect mask 230, also referred to as an example defect mask latent 350, having reduced dimensionality relative to the defect mask 230. In some examples, the defect mask latent 350 has dimensionality that corresponds to the dimensionality of the training defect image latent 340 and the masked training defect image latent 345. For example, if the defect mask 230 has dimensionality of H×W×1, where H represents the height of the training defect image 225 in pixels, W represents the width of the training defect image 225 in pixels, and 1 represents the binary values of the defect mask 230, the defect mask latent 350 may have a dimensionality of H/D×W/D×1, where D represents a dimensionality reduction factor of the encoder circuitry 305, as described above. In some examples the mask transformation circuitry 310 implements any appropriate downsampling technique to transform the defect mask 230 to the defect mask latent 350.

The noise circuitry 315 of the illustrated example iteratively generates and adds noise (e.g., noise samples) to the training defect image latent 340 to produce a corresponding example noisy defect image latent 355 at each tuning iteration implemented by the diffusion model tuning circuitry 205. In some examples, the noise circuitry 315 iteratively generates the noise (e.g., noise samples) at each tuning iteration based on a noise schedule used to tune the diffusion model 245. In some examples, the noise circuitry 315 generates the noise (e.g., noise samples) based on a probability distribution, such as a Gaussian distribution.

The concatenation circuitry 320 of the illustrated example combines the masked training defect image latent 345, the noisy defect image latent 355 and the defect mask latent 350 to produce example diffusion model input data 360 to be provided to the denoise circuitry 325. In some examples, the concatenation circuitry 320 concatenates the masked training defect image latent 345, the noisy defect image latent 355 and the defect mask latent 350 to produce the diffusion model input data 360.

The denoise circuitry 325 of the illustrated example implements one or more AI models to be tuned to predict the noise added to the training defect image latent 340 to produce the noisy defect image latent 355. In the illustrated example, the AI model(s) of the denoise circuitry 325 perform noise prediction based on input data including the diffusion model input data 360 (e.g., the combination/concatenation of the masked training defect image latent 345, the noisy defect image latent 355 and the defect mask latent 350) and the defect description data 240 that describes the defect(s) depicted in the training defect image 225. For example, the diffusion model input data 360 (e.g., the combination/concatenation of the masked training defect image latent 345, the noisy defect image latent 355 and the defect mask latent 350) may be applied to the input layer(s) of the AI model(s), and the defect description data 240 may be applied as a conditional input (e.g., a condition) to the AI model(s). In some examples, the denoise circuitry 325 and/other circuitry of the diffusion model tuning circuitry 205 implements a text encoder to encode a text string, which is descriptive of the defect(s) depicted in the training defect image 225 (e.g., the “damaged box” text string illustrated in FIG. 3), to generate the defect description data 240.

In some examples, the AI model(s) implemented by the denoise circuitry 325 includes a convolutional neural network (CNN), such as a U-Net. In some examples, the U-Net is pretrained to perform noise prediction generally, and the diffusion model tuning circuitry 205 operates to tune the U-Net based on a relatively small set of training defect images 225 (e.g., such as tens of such images) to predict noise added to images depicting defect(s) of interest. In some examples, the diffusion model to be tuned refers to the U-Net and/or other AI models tuned by the denoise circuitry 325.

In the illustrated example of FIG. 3, at each tuning iteration, the denoise circuitry 325 executes or otherwise implements the U-Net and/or other AI model(s) to predict the noise added to the training defect image latent 340 to produce the noisy defect image latent 355 at the iteration. The denoise circuitry 325 then outputs the predicted noise for that iteration as an example estimated noise latent 365. In some examples, the example estimated noise latent 365 has the same dimensionality as the training defect image latent 340.

The noise removal circuitry 330 of the illustrated example uses the estimated noise latent 365 to attempt to remove the noise from the noisy defect image latent 355. In some examples, the noise removal circuitry 330 subtracts the estimated noise latent 365 from the noisy defect image latent 355 to produce an example denoised defect image latent 370.

The decoder circuitry 335 of the illustrated example decodes the denoised defect image latent 370 from the latent space back to the pixel space to produce an example estimated defect image 375. For example, the decoder circuitry 335 may be trained or otherwise implemented to reverse the encoding operations (e.g., variational autoencoding operations) performed by the encoder circuitry 305. As the U-Net and/or other AI model(s) implemented by the denoise circuitry 325 is/are tuned over successive iterations, the difference (e.g., error) between the estimated defect image 375 and the original training defect image 225 reduces and the estimated defect image 375 becomes more of an accurate representation of the original training defect image 225.

To tune the U-Net and/or other AI model(s) to improve noise prediction accuracy, the denoise circuitry 325 of the illustrated example computes any appropriate loss function (e.g., such as mean squared error (MSE)) that represents the difference between the estimated defect image 375 and the original training defect image 225 at a given tuning iteration. The denoise circuitry 325 then uses the output of the loss function to update the parameters (e.g., weights) of the U-Net and/or other AI model(s) based on any appropriate update algorithm (e.g., such as gradient descent and/or some other algorithm). In some examples, the denoise circuitry 325 triggers successive tuning iterations of the diffusion model tuning circuitry 205 until one or more stopping criteria are met. Examples of such stopping criteria may include, but are not limited to, (i) conclusion of a specified number of training iterations, (ii) determination that the output of the loss function satisfies (e.g., is less than or equal to) a convergence threshold, (iii) use of all of the available training defect image(s) 225, etc. After the one or more stopping criteria are met, the diffusion model tuning circuitry 205 outputs the tuned parameters (e.g., weights) of the U-Net and/or other AI model(s) implemented by the denoise circuitry 325 as the tuned diffusion model 245. As such, in the illustrated example of FIG. 3, the parameters of the U-Net and/or other AI model(s) implemented by the denoise circuitry 325 correspond to the tunable parameters of the diffusion model 245. In some examples, the diffusion model tuning circuitry 205 also includes the parameters used by the encoder circuitry 305 and/or the decoder circuitry 335 in the output tuned diffusion model 245.

FIG. 4 is a block diagram of an example implementation of the synthetic image generation circuitry 210 of FIG. 2. The synthetic image generation circuitry 210 of FIG. 4 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the synthetic image generation circuitry 210 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example synthetic image generation circuitry 210 of FIG. 4 includes example encoder circuitry 405, example mask transformation circuitry 410, example noise generation circuitry 415, example concatenation circuitry 420, example denoise circuitry 425, example noise removal circuitry 430 and example decoder circuitry 435 to implement the trained diffusion model 245 to generate the synthetic images 250, as described above. The encoder circuitry 405 of the illustrated example accepts as input an example masked input image 235 generated by applying an example mask 260 to a corresponding input image into which one or more defects are to be inpainted. In some examples, the mask 260 specifies one or more bounding boxes that that define the locations and/or dimensions of the defect region(s) into which synthetic defect(s) is/are to be inpainted into an input image to generate a corresponding synthetic image 250. In some examples, the bounding box(es) of the mask 260 are specified by user input data. In some examples, the input mask 260 is a binary mask with a first value (e.g., 0) used to represent masked region(s) (e.g., the bounding box(es)) of the input image and a second value (e.g., 1) used to represent unmasked region(s) of the input image. In some such examples, the encoder circuitry 305 and/or other circuitry of the synthetic image generation circuitry 210 multiplies the input by the input mask 260 to determine the masked input image 255.

Similar to the encoder circuitry 305 described above in connection with FIG. 3, the example encoder circuitry 405 of FIG. 4 encodes the masked input image 255 from an original pixel space into a reduced dimensionality latent space to generate and output an example latent version of the masked input image 255, also referred to as an example masked input image latent 445. For example, if the masked input image 255 has a pixel space dimensionality of H×W×3, where H represents the height of the image in pixels, W represents the width of the image in pixels, and 3 corresponds to the number of color channels (e.g., red, green, and blue in RGB format, or luminance (Y) and chrominance (U,V) in YUV format), the masked input image latent 445 may have a dimensionality of H/D×W/D×C, where D represents a dimensionality reduction factor, and C represents the number of output channels of the masked input image latent 445. In some examples, the encoder circuitry 405 implements an example VAE trained to encode the masked input image 255 into the masked input image latent 445. In some examples, the coding parameters of the encoder circuitry 405 (e.g., such as the parameters of the VAE 405) are obtained from the trained diffusion model 245 output from the diffusion model tuning circuitry 205.

Similar to the mask transformation circuitry 310 described above in connection with FIG. 3, the example mask transformation circuitry 410 of FIG. 4 transforms the input mask 260 into an example latent version of the input mask 260, also referred to as an example input mask latent 450, having reduced dimensionality relative to the input mask 260. In some examples, the input mask latent 450 has dimensionality that corresponds to the dimensionality of the masked input image latent 445. For example, if the input mask 260 has dimensionality of H×W×1, where H represents the height of the masked input image 255 in pixels, W represents the width of the masked input image 255 in pixels, and 1 represents the binary values of the input mask 260, the input mask latent 450 may have a dimensionality of H/D×W/D×1, where D represents a dimensionality reduction factor of the encoder circuitry 405, as described above. In some examples the mask transformation circuitry 410 implements any appropriate downsampling technique to transform the input mask 260 to the input mask latent 450.

The noise circuitry 415 of the illustrated example iteratively generates example noise 455 (e.g., noise samples 455) to be used by the synthetic image generation circuitry 210 at each diffusion iteration to synthesize defect(s) to be inpainted in the masked regions of the masked input image 255. In some examples, the noise circuitry 415 iteratively generates the noise (e.g., noise samples) at each tuning iteration based on a noise schedule used by the trained diffusion model 245. In some examples, the noise circuitry 415 generates the noise (e.g., noise samples) based on a probability distribution, such as a Gaussian distribution.

Similar to the concatenation circuitry 320 described above in connection with FIG. 3, the example concatenation circuitry 420 of FIG. 4 combines the masked input image latent 445, the generate noise 455 and the input mask latent 450 and the defect description data 270 that describes the defect(s) to be inpainted into the masked input image 255 to produce example diffusion model input data 460 to be provided to the denoise circuitry 425. In some examples, the concatenation circuitry 320 concatenates the masked input image latent 445, the generate noise 455 and the input mask latent 450 to produce the diffusion model input data 460.

Similar to the denoise circuitry 325 described above in connection with FIG. 3, the example denoise circuitry 425 of the illustrated example implements one or more AI models to be tuned to predict the estimated noise latent 465 that, removed from the input noise 455, would result in the synthesize defect(s) corresponding to the defect description data 270. In the illustrated example, the AI model(s) of the denoise circuitry 425 perform noise prediction based on input data including the diffusion model input data 460 (e.g., the combination/concatenation of the masked input image latent 445, the noise 455 and the input mask latent 450) and the defect description data 270 that describes the defect(s) to be inpainted into the masked input image 255. For example, the diffusion model input data 460 (e.g., the combination/concatenation of the masked input image latent 445, the noise 455 and the input mask latent 450) may be applied to the input layer(s) of the AI model(s), and the defect description data 270 may be applied as a conditional input (e.g., a condition) to the AI model(s). In some examples, the denoise circuitry 425 and/other circuitry of the synthetic image generation circuitry 210 implements a text encoder to encode a text string, which is descriptive of the defect(s) to be synthesized into the masked input image 255 (e.g., the “damaged box” text string illustrated in FIG. 4), to generate the defect description data 270.

In some examples, the AI model(s) implemented by the denoise circuitry 425 includes a CNN, such as a U-Net. In some examples, the U-Net and/or other AI model(s) of the denoise circuitry 425 are obtained from the trained diffusion model 245 output from the diffusion model tuning circuitry 205. In some examples, the tuned diffusion model refers to the U-Net and/or other AI models used by the denoise circuitry 425.

In the illustrated example of FIG. 4, at each diffusion iteration, the denoise circuitry 425 executes or otherwise implements the U-Net and/or other AI model(s) to predict and output the estimated noise latent 465 based on the diffusion model input data 460. In some examples, the example estimated noise latent 465 has the same dimensionality as the masked input image latent 445.

Similar to the noise removal circuitry 330 described above in connection with FIG. 3, the example noise removal circuitry 430 of FIG. 4 removes the estimated noise latent 365 from the generated noise 455. In some examples, the noise removal circuitry 430 subtracts the estimated noise latent 465 from the generated noise 455 to produce an example denoised synthetic image latent 470.

Similar to the decoder circuitry 335 described above in connection with FIG. 3, the example decoder circuitry 435 of FIG. 4 decodes the denoised synthetic image latent 470 from the latent space back to the pixel space to produce an example synthetic image 250. For example, the decoder circuitry 435 may implement the reverse of the encoding operations (e.g., variational autoencoding operations) performed by the encoder circuitry 405. In some examples, the decoding parameters of the decoder circuitry 435 are obtained from the trained diffusion model 245 output from the diffusion model tuning circuitry 205.

In the illustrated example synthetic image generation circuitry 210 of FIG. 4, the U-Net and/or other AI model(s) implemented by the denoise circuitry 425 operate over successive denoise iterations to reduce the error in the synthetic image 250. In some examples, the synthetic image generation circuitry 210 performs successive diffusion iterations until one or more stopping criteria are met. Examples of such stopping criteria may include, but are not limited to, (i) conclusion of a specified number of diffusion iterations, (ii) determination that a difference (e.g., MSE) between the synthetic image 250 generated at a current diffusion iteration and the synthetic image 250 generated at a preceding diffusion iteration satisfies (e.g., is less than or equal to) a difference threshold, etc. After the one or more stopping criteria are met, the diffusion model tuning circuitry 205 outputs the synthetic image 250 as the generated synthetic image 250 corresponding to the masked input image 255 but inpainted to include defect(s) corresponding to the defect description data 270 in the masked region(s) specified by the input mask 260.

While an example manner of implementing the AI model provisioning system 135 is illustrated in FIGS. 2-4, one or more of the elements, processes, and/or devices illustrated in FIGS. 2-4 may be combined, divided, re-arranged, omitted, eliminated, and/or implemented in any other way. Further, the example diffusion model tuning circuitry 205, the example synthetic image generation circuitry 210, the example image filtering circuitry 215, the example AI model training circuitry 220, the example encoder circuitry 305, the example mask transformation circuitry 310, the example noise generation circuitry 315, the example concatenation circuitry 320, the example denoise circuitry 325, the example noise removal circuitry 330, the example decoder circuitry 335, the encoder circuitry 405, the example mask transformation circuitry 410, the example noise generation circuitry 415, the example concatenation circuitry 420, the example denoise circuitry 425, the example noise removal circuitry 430, the example decoder circuitry 435, and/or, more generally, the example AI model provisioning system 135 of FIGS. 2-4, may be implemented by hardware alone or by hardware in combination with software and/or firmware. Thus, for example, any of the example diffusion model tuning circuitry 205, the example synthetic image generation circuitry 210, the example image filtering circuitry 215, the example AI model training circuitry 220, the example encoder circuitry 305, the example mask transformation circuitry 310, the example noise generation circuitry 315, the example concatenation circuitry 320, the example denoise circuitry 325, the example noise removal circuitry 330, the example decoder circuitry 335, the encoder circuitry 405, the example mask transformation circuitry 410, the example noise generation circuitry 415, the example concatenation circuitry 420, the example denoise circuitry 425, the example noise removal circuitry 430, the example decoder circuitry 435 and/or, more generally, the example the AI model provisioning system 135, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example AI model provisioning system 135 of FIGS. 2-4 may include one or more elements, processes, and/or devices in addition to, or instead of, those illustrated in FIGS. 2-4, and/or may include more than one of any or all of the illustrated elements, processes and devices.

Flowchart(s) representative of example machine-readable instructions, which may be executed by programmable circuitry to implement and/or instantiate the AI model provisioning system 135 of FIGS. 2-4 and/or representative of example operations which may be performed by programmable circuitry to implement and/or instantiate the AI model provisioning system 135 of FIGS. 2-4, are shown in FIGS. 5-9. The machine-readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 5-9, many other methods of implementing the example AI model provisioning system 135 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 5-9 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 5 is a flowchart representative of example machine-readable instructions and/or example operations 500 that may be executed, instantiated, and/or performed by programmable circuitry to implement the example AI model provisioning system 135 of FIGS. 1-4. The example machine-readable instructions and/or the example operations 500 of FIG. 5 begin at block 505, at which the diffusion model tuning circuitry 205 of the AI model provisioning system 135 tunes a diffusion model to inpaint defects corresponding to defect descriptions into masked regions of a set of input images, as described above. At block 510, the synthetic image generation circuitry 210 of the AI model provisioning system 135 obtains, as described above, an initial set of synthetic images based on the diffusion model, with the initial set of synthetic images corresponding to the set of input images. At block 515, the image filtering circuitry 215 of the AI model provisioning system 135 filters one or more outlier images from the initial set of synthetic images to generate a filtered set of synthetic images that excludes the one or more outlier images, as described above. At block 520, the AI model training circuitry 220 of the AI model provisioning system 135 trains an AI model based on the filtered set of synthetic images, as described above. The example machine-readable instructions and/or example operations 500 then end.

FIG. 6 is a flowchart representative of example machine-readable instructions and/or example operations 510 that may be executed, instantiated, and/or performed by programmable circuitry to implement the processing at block 510 of FIG. 5 and/or synthetic image generation in the example AI model provisioning system 135 of FIGS. 1-4. The example machine-readable instructions and/or the example operations 510 of FIG. 6 begin at block 605, at which the synthetic image generation circuitry 210 accesses a given input image that is to be used to generate a corresponding synthetic image including one or more defects. At block 610, the synthetic image generation circuitry 210 generates input data for the tuned diffusion model based on a combination of a masked input image, a mask used to generate the masked input image from an input image and a defect description, as described above. At block 610, the synthetic image generation circuitry 210 generates a synthetic image based on an output of the tuned diffusion model, with the output and, thus, the synthetic image being based on the input data, as described above. At block 615, the synthetic image generation circuitry 210 outputs and/or stores the synthetic image for use in the training of one or more AI models, as described above. At block 620, the synthetic image generation circuitry 210 determines whether there are other input images to process. If there are other input images to process (corresponding to the “YES” output of block 620), processing returns to block 605 and blocks subsequent thereto via which the synthetic image generation circuitry 210 generates another synthetic defect image based on another input image. However, if there are no other input images to process (corresponding to the “NO” output of block 620), the machine-readable instructions and/or example operations 510 end.

FIG. 7 is a flowchart representative of example machine-readable instructions and/or example operations 610 that may be executed, instantiated, and/or performed by programmable circuitry to implement the processing at block 610 of FIG. 6 and/or diffusion mode input data generation in the example AI model provisioning system 135 of FIGS. 1-4. The example machine-readable instructions and/or the example operations 610 of FIG. 7 begin at block 705, at which the synthetic image generation circuitry 210 encodes the masked input image to generate a latent version of the masked input image, as described above. At block 710, the synthetic image generation circuitry 210 transforms the mask, which was used to generate the masked input image, based on the dimensionality of the latent version of the masked input image to generate a latent version of the mask, as described above. At block 715, the synthetic image generation circuitry 210 generate noise based on a noise distribution, as described above. At block 720, the synthetic image generation circuitry 210 encodes a text string descriptive of the defect to generate the defect description, as described above. At block 725, the synthetic image generation circuitry 210 concatenates the latent version of the masked input image, the noise and the latent version of the mask to generate the diffusion model input data, as described above. At block 730, the synthetic image generation circuitry 210 generates conditional input data for the diffusion model based on the defect description, as described above. The example machine-readable instructions and/or example operations 610 then end.

FIG. 8 is a flowchart representative of example machine-readable instructions and/or example operations 505 that may be executed, instantiated, and/or performed by programmable circuitry to implement the processing at block 505 of FIG. 5 and/or diffusion model tuning in the example AI model provisioning system 135 of FIGS. 1-4. The example machine-readable instructions and/or the example operations 505 of FIG. 8 begin at block 805, at which the diffusion model tuning circuitry 205 obtains a trained diffusion model. At block 810, the diffusion model tuning circuitry 205 generates tuning data based on a training image, a masked training image, a mask used to generate the masked training image from the training image, and a defect description identifying a defect in a masked region of the training image, as described above. At block 815, the diffusion model tuning circuitry 205 tunes the trained diffusion model based on the tuning data to inpaint the defect into the masked region of the masked training image, as described above. At block 820, the diffusion model tuning circuitry 205 outputs the tuned diffusion model, as described above. The example machine-readable instructions and/or the example operations 505 then end.

FIG. 9 is a flowchart representative of example machine-readable instructions and/or example operations 810 that may be executed, instantiated, and/or performed by programmable circuitry to implement the processing at block 810 of FIG. 8 and/or diffusion model tuning data generation in the example AI model provisioning system of FIGS. 1-4. The example machine-readable instructions and/or the example operations 810 of FIG. 9 begin at block 905, at which the diffusion model tuning circuitry 205 encodes a training image to generate a latent version of the training image, as described above. At block 910, the diffusion model tuning circuitry 205 encodes the masked training image to generate a latent version of the masked training image, as described above. At block 915, the diffusion model tuning circuitry 205 transforms the mask, which was used to generate the masked training image, based on the dimensionality of the latent versions of the training image and masked training image to generate a latent version of the mask, as described above. At block 920, the diffusion model tuning circuitry 205 adds noise to the latent version of the training image based on a noise distribution to generate a noisy latent version of the training image, as described above. At block 925, the diffusion model tuning circuitry 205 encodes a text string descriptive of the defect to generate the defect description, as described above. At block 930, the diffusion model tuning circuitry 205 concatenates the latent version of the masked input image, the noisy latent version of the training image and the latent version of the mask to generate the diffusion model input tuning data, as described above. At block 935, the diffusion model tuning circuitry 205 generates conditional input tuning data for the diffusion model based on the defect description, as described above. The example machine-readable instructions and/or example operations 810 then end.

FIG. 10 is a block diagram of an example programmable circuitry platform 1000 structured to execute and/or instantiate the example machine-readable instructions and/or the example operations of FIGS. 5-9 to implement the AI model provisioning system 135 of FIGS. 2-4. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, VPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example diffusion model tuning circuitry 205, the example synthetic image generation circuitry 210, the example image filtering circuitry 215, the example AI model training circuitry 220, the example encoder circuitry 305, the example mask transformation circuitry 310, the example noise generation circuitry 315, the example concatenation circuitry 320, the example denoise circuitry 325, the example noise removal circuitry 330, the example decoder circuitry 335, the encoder circuitry 405, the example mask transformation circuitry 410, the example noise generation circuitry 415, the example concatenation circuitry 420, the example denoise circuitry 425, the example noise removal circuitry 430, the example decoder circuitry 435, and/or, more generally, the example AI model provisioning system 135.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1032, which may be implemented by the machine-readable instructions of FIGS. 5-9, may be stored in the mass storage device 1028, in the volatile memory 1014, in the non-volatile memory 1016, and/or on at least one non-transitory computer-readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 5-9 to effectively instantiate the circuitry of FIGS. 2-4 as logic circuits to perform operations corresponding to those machine-readable instructions. In some such examples, the circuitry of FIGS. 2-4 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine-readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine-readable instructions and/or operations represented by the flowcharts of FIGS. 5-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine-readable instructions. However, once configured, the FPGA circuitry 1200 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine-readable instructions represented by the flowchart(s) of FIGS. 5-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 5-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-9. As such, the FPGA circuitry 1200 may be configured and/or structured to effectively instantiate some or all of the operations/functions corresponding to the machine-readable instructions of the flowchart(s) of FIGS. 5-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine-readable instructions of FIGS. 5-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine-readable instructions of FIGS. 5-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine-readable instructions represented by the flowchart(s) of FIGS. 5-9 to perform first operation(s)/function(s), the FPGA circuitry 1200 of FIG. 12 may be configured and/or structured to perform second operation(s)/function(s) corresponding to a second portion of the machine-readable instructions represented by the flowcharts of FIGS. 5-9, and/or an ASIC may be configured and/or structured to perform third operation(s)/function(s) corresponding to a third portion of the machine-readable instructions represented by the flowcharts of FIGS. 5-9.

It should be understood that some or all of the circuitry of FIGS. 2-4 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIGS. 2-4 may be instantiated, for example, in one or more threads executing concurrently and/or in series. For example, the microprocessor 1100 of FIG. 11 may execute machine-readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIGS. 2-4 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

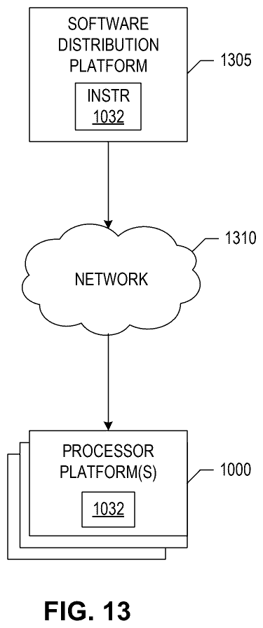

A block diagram illustrating an example software distribution platform 1305 to distribute software such as the example machine-readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine-readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine-readable instructions of FIGS. 5-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1032 from the software distribution platform 1305. For example, the software, which may correspond to the example machine-readable instructions of FIG. 5-9, may be downloaded to the example programmable circuitry platform 1000, which is to execute the machine-readable instructions 1032 to implement the AI model provisioning system 135. In some examples, one or more servers of the software distribution platform 1305 periodically offer, transmit, and/or force updates to the software (e.g., the example machine-readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that generate synthetic images for training of defect detection models. Disclosed systems, apparatus, articles of manufacture, and methods improve the efficiency of using a computing device by utilizing generative AI (e.g., implemented via a diffusion model) to generate synthetic pallet defect mages to enable training of a downstream defect detection model with a sufficient amount of training data to meet a target/desired accuracy. As such, examples disclosed herein provide a technical solution to the problems associated with obtaining sufficient training data for defect detection models. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to generation of synthetic images for training of defect detection models are disclosed herein. Further examples and combinations thereof include the following.

Example 1 includes an apparatus comprising interface circuitry, machine-readable instructions, and at least one programmable circuit to be programmed based on the machine-readable instructions to generate input data for a diffusion model based on a combination of a masked input image, a mask used to generate the masked input image from an input image, and a defect description, the diffusion model tuned to inpaint a defect corresponding to the defect description into a masked region of the masked input image, execute the diffusion model based on the input data to generate a synthetic image, and at least one of output the synthetic image or cause storage of the synthetic image.

Example 2 includes the apparatus of example 1, wherein the diffusion model is a latent diffusion model, and one of more of the at least one programmable circuit is to generate a masked input image latent based on the masked input image, generate a mask latent based on the mask, and concatenate the masked input image latent and the mask latent to determine the input data.

Example 3 includes the apparatus of example 2, wherein one or more of the at least one programmable circuit is to encode the masked input image to generate the masked input image latent, the masked input image latent having a reduced dimensionality relative to the masked input image.

Example 4 includes the apparatus of example 3, wherein one or more of the at least one programmable circuit is to transform the mask based on the reduced dimensionality of the masked input image latent to generate the mask latent.

Example 5 includes the apparatus of any one or more of examples 1-4, wherein one of more of the at least one programmable circuit is to generate the input data based on noise.

Example 6 includes the apparatus of example 5, wherein one of more of the at least one programmable circuit is to generate the noise based on a Gaussian distribution.

Example 7 includes the apparatus of any one or more of examples 5-6, wherein the diffusion model is a latent diffusion model, and one of more of the at least one programmable circuit is to generate a masked input image latent based on the masked input image, generate a mask latent based on the mask, and concatenate the masked input image latent, the noise and the mask latent to determine the input data.

Example 8 includes the apparatus of any one or more of examples 1-7, wherein the synthetic image corresponds to the masked input image modified with the defect inpainted into the masked region of the masked input image.

Example 9 includes the apparatus of any one or more of examples 1-8, wherein one of more of the at least one programmable circuit is to train a machine learning model based on the synthetic image.

Example 10 includes the apparatus of any one or more of examples 1-9, wherein one of more of the at least one programmable circuit is to obtain a first set of synthetic images based on outputs from the diffusion model, the first set of synthetic images based on respective combinations of masked input images, masks used to generate the masked input images from corresponding input images, and corresponding defect descriptions, filter one or more outlier images from the first set of synthetic images to generate a second set of synthetic images, the second set of synthetic images to exclude the one or more outlier images, and at least one of output the second set of synthetic images or cause storage of the second set of synthetic image.

Example 11 includes the apparatus of example 10, wherein one of more of the at least one programmable circuit is to train a machine learning model based on a training set including the second set of synthetic images and a set of real images.

Example 12 includes the apparatus of any one or more of examples 1-11, wherein the mask is a first mask, the defect is a first defect, the defect description is a first defect description, and the diffusion model is tuned based on a training image, a masked training image, a second mask associated with generation of the masked training image from the training image, and a second defect description, a masked region of the training image including a second defect corresponding to the second defect description.

Example 13 includes the apparatus of example 12, wherein the diffusion model is a tuned diffusion model, and one or more of the at least one programmable circuit is to tune a trained diffusion model based on the training image, the masked training image, the second mask, and the second defect description to generate the tuned diffusion model.

Example 14 includes the apparatus of any one or more of examples 1-13, wherein one or more of the at least one programmable circuit is to encode a text string to generate the defect description, the text string descriptive of the defect.

Example 15 includes at least one non-transitory machine-readable storage medium comprising machine-readable instructions to cause at least one programmable circuit to at least generate a first set of synthetic images based on a latent diffusion model tuned to inpaint defects corresponding to defect descriptions into masked regions of a set of input images, filter one or more outlier images from the first set of synthetic images to generate a second set of synthetic images, the second set of synthetic images to exclude the one or more outlier images, and train a machine learning model based on the second set of synthetic images.

Example 16 includes the at least one non-transitory machine-readable storage medium of example 15, wherein the machine-readable instructions are to cause one or more of the at least one programmable circuit to apply a first mask to a first input image of the set of input images to generate a first masked input image, encode the first masked input image to generate a first masked input image latent, transform the first mask based on a dimensionality of the first masked input image latent to generate a first mask latent, concatenate the first masked input image latent, noise and the first mask latent to generate input data for the latent diffusion model, and generate a first synthetic image of the first set of synthetic images based on an output of the latent diffusion model, the output of the latent diffusion model based on the input data and a first defect description, the first synthetic image corresponding to the first masked input image modified with a first defect inpainted into a masked region of the first masked input image, the first defect corresponding to the first defect description.

Example 17 includes the at least one non-transitory machine-readable storage medium of any one or more of examples 15-16, wherein the latent diffusion model is a tuned latent diffusion model, and the machine-readable instructions are to cause one or more of the at least one programmable circuit to tune a trained diffusion model based on a training image, a masked training image, a second mask associated with generation of the masked training image from the training image, and a second defect description to generate the tuned latent diffusion model, a masked region of the training image including a second defect corresponding to the second defect description.

Example 18 includes the at least one non-transitory machine-readable storage medium of example 15, wherein the machine-readable instructions are to cause one or more of the at least one programmable circuit to apply a first mask to a first input image of the set of input images to generate a first masked input image, generate first input data for the diffusion model based on a combination of the first masked input image, the first mask, and noise, the diffusion model tuned to inpaint a first defect corresponding to a first defect description into a masked region of the first masked input image, and generate a first synthetic image of the first set of synthetic images based on an output of the diffusion model, the output of the diffusion model based on the first input data and the first defect description.

Example 19 includes the at least one non-transitory machine-readable storage medium of example 18, wherein the diffusion model is a latent diffusion model, and the machine-readable instructions are to cause one or more of the at least one programmable circuit to encode the first masked input image to generate a first masked input image latent, transform the first mask to generate a first mask latent, and concatenate the first masked input image latent, the noise and the first mask latent to generate the first input data.

Example 20 includes the at least one non-transitory machine-readable storage medium of example 19, wherein the first masked input image latent has a reduced dimensionality relative to the first masked input image.

Example 21 includes the at least one non-transitory machine-readable storage medium of example 20, wherein the transform is based on the reduced dimensionality of the first masked input image.

Example 22 includes the at least one non-transitory machine-readable storage medium of any one or more of examples 18-21, wherein the machine-readable instructions are to cause one or more of the at least one programmable circuit to generate the noise based on a Gaussian distribution.

Example 23 includes a system comprising means for generating synthetic images, the means for generating synthetic images to generate a first set of synthetic images based on a latent diffusion model tuned to inpaint defects corresponding to defect descriptions into masked regions of a set of input images, means for filtering one or more outlier images from the first set of synthetic images to generate a second set of synthetic images, the second set of synthetic images to exclude the one or more outlier images, and means for training a machine learning based on the second set of synthetic images.

Example 24 includes the system of example 23, wherein the means for generating synthetic images is to apply a first mask to a first input image of the set of input images to generate a first masked input image, encode the first masked input image to generate a first masked input image latent, transform the first mask based on a dimensionality of the first masked input image latent to generate a first mask latent, concatenate the first masked input image latent, noise and the first mask latent to generate input data for the latent diffusion model, and generate a first synthetic image of the first set of synthetic images based on an output of the latent diffusion model, the output of the latent diffusion model based on the input data and a first defect description, the first synthetic image corresponding to the first masked input image modified with a first defect inpainted into a masked region of the first input image, the first defect corresponding to the first defect description.

Example 25 includes the system of any one or more of examples 23-24, wherein the latent diffusion model is a tuned latent diffusion model, and including means for tuning a trained diffusion model based on a training image, a masked training image, a second mask associated with generation of the masked training image from the training image, and a second defect description to generate the tuned latent diffusion model, a masked region of the training image including a second defect corresponding to the second defect description.

Example 26 includes a method performed by any one or more of the apparatus of examples 1 to 15.

Example 27 includes a method performed by any one or more of the systems of examples 23 to 25.

Example 28 includes at least one machine-readable medium comprising the machine-readable instructions of any one or more of the apparatus of examples 1 to 15.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one programmable circuit to be programmed based on the machine-readable instructions to:
generate input data for a diffusion model based on a combination of a masked input image, a mask used to generate the masked input image from an input image, and a defect description, the diffusion model tuned to inpaint a defect corresponding to the defect description into a masked region of the masked input image;
execute the diffusion model based on the input data to generate a synthetic image; and
output the synthetic image.

2. The apparatus of claim 1, wherein the diffusion model is a latent diffusion model, and one of more of the at least one programmable circuit is to:
generate a masked input image latent based on the masked input image;
generate a mask latent based on the mask; and
concatenate the masked input image latent and the mask latent to determine the input data.

3. The apparatus of claim 2, wherein one or more of the at least one programmable circuit is to encode the masked input image to generate the masked input image latent, the masked input image latent having a reduced dimensionality relative to the masked input image.

4. The apparatus of claim 3, wherein one or more of the at least one programmable circuit is to transform the mask based on the reduced dimensionality of the masked input image latent to generate the mask latent.

5. The apparatus of claim 1, wherein one of more of the at least one programmable circuit is to generate the input data based on noise.

6. The apparatus of claim 5, wherein one of more of the at least one programmable circuit is to generate the noise based on a Gaussian distribution.

7. The apparatus of claim 5, wherein the diffusion model is a latent diffusion model, and one of more of the at least one programmable circuit is to:
generate a masked input image latent based on the masked input image;
generate a mask latent based on the mask; and
concatenate the masked input image latent, the noise and the mask latent to determine the input data.

8. The apparatus of claim 1, wherein the synthetic image corresponds to the masked input image modified with the defect inpainted into the masked region of the masked input image.

9. The apparatus of claim 1, wherein one of more of the at least one programmable circuit is to train a machine learning model based on the synthetic image.

10. The apparatus of claim 1, wherein one or more of the at least one programmable circuit is to encode a text string to generate the defect description, the text string descriptive of the defect.

11. At least one non-transitory machine-readable storage medium comprising machine-readable instructions to cause at least one programmable circuit to at least:
generate a first set of synthetic images based on a diffusion model tuned to inpaint defects corresponding to defect descriptions into masked regions of a set of input images;
filter one or more outlier images from the first set of synthetic images to generate a second set of synthetic images, the second set of synthetic images to exclude the one or more outlier images; and
train a machine learning model based on the second set of synthetic images.

12. The at least one non-transitory machine-readable storage medium of claim 11, wherein the machine-readable instructions are to cause one or more of the at least one programmable circuit to:
apply a first mask to a first input image of the set of input images to generate a first masked input image;
generate first input data for the diffusion model based on a combination of the first masked input image, the first mask, and noise, the diffusion model tuned to inpaint a first defect corresponding to a first defect description into a masked region of the first masked input image; and
generate a first synthetic image of the first set of synthetic images based on an output of the diffusion model, the output of the diffusion model based on the first input data and the first defect description.

13. The at least one non-transitory machine-readable storage medium of claim 12, wherein the diffusion model is a latent diffusion model, and the machine-readable instructions are to cause one or more of the at least one programmable circuit to:
encode the first masked input image to generate a first masked input image latent;
transform the first mask to generate a first mask latent; and
concatenate the first masked input image latent, the noise and the first mask latent to generate the first input data.

14. The at least one non-transitory machine-readable storage medium of claim 13, wherein the first masked input image latent has a reduced dimensionality relative to the first masked input image.

15. The at least one non-transitory machine-readable storage medium of claim 14, wherein the transform is based on the reduced dimensionality of the first masked input image.

16. The at least one non-transitory machine-readable storage medium of claim 12, wherein the machine-readable instructions are to cause one or more of the at least one programmable circuit to generate the noise based on a Gaussian distribution.

17. The at least one non-transitory machine-readable storage medium of claim 15, wherein the diffusion model is a tuned latent diffusion model, and the machine-readable instructions are to cause one or more of the at least one programmable circuit to tune a trained latent diffusion model based on a training image, a masked training image, a second mask associated with generation of the masked training image from the training image, and a second defect description to generate the tuned latent diffusion model, a masked region of the training image including a second defect corresponding to the second defect description.

18. A system comprising:
means for generating synthetic images, the means for generating synthetic images to generate a first set of synthetic images based on a latent diffusion model tuned to inpaint defects corresponding to defect descriptions into masked regions of a set of input images;
means for filtering one or more outlier images from the first set of synthetic images to generate a second set of synthetic images, the second set of synthetic images to exclude the one or more outlier images; and
means for training a machine learning based on the second set of synthetic images.

19. The system of claim 18, wherein the means for generating synthetic images is to:
apply a first mask to a first input image of the set of input images to generate a first masked input image;
encode the first masked input image to generate a first masked input image latent;
transform the first mask based on a dimensionality of the first masked input image latent to generate a first mask latent;
concatenate the first masked input image latent, noise and the first mask latent to generate input data for the latent diffusion model; and
generate a first synthetic image of the first set of synthetic images based on an output of the latent diffusion model, the output of the latent diffusion model based on the input data and a first defect description, the first synthetic image corresponding to the first masked input image modified with a first defect inpainted into a masked region of the first input image, the first defect corresponding to the first defect description.

20. The system of claim 18, wherein the latent diffusion model is a tuned latent diffusion model, and including means for tuning a trained diffusion model based on a training image, a masked training image, a second mask associated with generation of the masked training image from the training image, and a second defect description to generate the tuned latent diffusion model, a masked region of the training image including a second defect corresponding to the second defect description.
